(19) United States
(12) Patent Application Publication
(10) Pub. No.: US 2012/0210822 A1
(43) Pub. Date: Aug. 23, 2012

(54) CEMENTED CARBIDE AND PROCESS FOR PRODUCING SAME

(76) Inventors: Igor Yuri Konyashin, Huenfeld (DE); Bernd Heinrich Ries, Huenfeld (DE); Frank Friedrich Lachmann, Burchaun (DE)

(21) Appl. No.: 13/500,072

(22) PCT Filed: Nov. 15, 2010
(86) PCT No.: PCT/EP2010/067463

§ 371 Date: May 10, 2012

(30) Foreign Application Priority Data
Nov. 13, 2009 (GB) 0919857.3

(51) Int. Cl. C22C 1/05; C22C 29/08; B82Y 30/00

(52) U.S. Cl. 75/236; 419/18; 977/773

(57) ABSTRACT

The present invention relates to a cemented carbide comprising WC grains, 3-20 wt. % binder selected from Co or Co and Ni and grain growth inhibitors wherein the WC mean grain size lies in the range of 180 nm and 230 nm, at least 10±2% WC grains are finer than 50 nm and 7±2% WC grains have a size from 50 to 100 nm. The invention further relates to a process for production the cemented carbide including the stages of milling WC powder with specific surface area (BET) of 3.0 m²/g or higher with binder and grain-growth inhibitors; pressing green parts; pre-sintering the green parts in H2 at 400° C. to 900° C. for 5 to 30 min; sintering in vacuum at temperatures of 1340° C. to 1410° C. for 3 min to 20 min; and HIP-sintering in Ar at pressures of 40 to 100 bar at temperatures of 1340° C. to 1410° C. for 1 to 20 min

### FIELD

This invention relates to cemented carbide comprising tungsten carbide (WC) grains with mean grain size of below 0.3 micron and to methods of making such cemented carbide.

### BACKGROUND

There is a general trend in the cemented carbide industry to produce WC—Co materials with WC mean grain size as low as possible, in particular having a grain size in the region of nanomaterials (grain size smaller than 0.1 micron or 100 nm). WC—Co hardmetals with a WC mean grain size of nearly 0.2 micron, produced from WC powders with a mean grain size of below 0.3 micron are designated as “near-nano cemented carbides” or “near-nano hardmetals” (see for example M. Brieseck, I. Hunsche et al. “Optimised sintering and grain-growth inhibition of ultrafine and near-nano hardmetals”. Proc. Int. Conf. PM2009, Copenhagen, EPMA). The near-nano cemented carbides are found to possess an improved combination of hardness and fracture toughness compared to conventional ultra-fine grained hardmetals with mean grain size of 0.3 to 0.8 μm.

EP1413637 discloses cemented carbide with improved toughness for oil and gas applications. The cemented carbide contains 8 wt. % to 12 wt. % Co+Ni, 1 wt. % to 2 wt. % Cr and 0.1 wt. % to 0.3 wt. % Mo, the rest being WC. All the WC grains are smaller than 1 micron and the magnetic Co content is between 80% and 90% of the chemically determined Co. The mean grain size of WC powder is nearly 0.8 micron. EP1413637 does not, however, provide information on the composition of near-nano cemented carbides.

EP1043412 discloses a method for making submicron cemented carbide with increased toughness. The WC grains of the WC powder according to EP1043412 are coated with Cr and Co prior to mixing. The WC grains have an average grain size in the range of 0.2 micron to 1.0 micron, preferably 0.6 micron to 0.9 micron. EP1043412 provides no information with respect to the fabrication of near-nano cemented carbides.

JP2005200671 describes a cemented carbide alloy having a d10, d50 and d90 particle diameter of 0.15 micron or less, 0.35 micron or less and 0.6 micron or less, respectively measured from the particle size distribution.

There are three major problems with respect to the production of near-nano cemented carbide from nano or near-nano WC powders. The first problem is related to the very intensive WC grain growth which occurs during the liquid-phase sintering of WC—Co when nano or near-nano powders are used. The WC grain growth can be suppressed by use of grain growth inhibitors, mainly chromium and vanadium carbides, however, only at the expense of cemented carbide fracture toughness.

The second problem is related to the very high activity of WC—Co green articles pressed from powder mixtures comprising nano or near-nano WC powders with respect to deviations of carbon content in the gas atmospheres during sintering. If the carbon potential in the sintering furnace is slightly above a certain level, free carbon forms in the microstructure of near-nano cemented carbides. If the carbon potential in the sintering furnace is slightly below a certain level, the decarburisation of near-nano cemented carbide can easily occur, leading to the formation of eta-phases (Co3W3C or Co6W6C) in the microstructure of near-nano cemented carbides.

The third problem is related to the necessity for fine regulation of the carbon content in powder WC—Co mixtures obtained from nano or near-nano powders. In the conventional practice of carbide fabrication, the carbon content is varied by addition of either W metal or carbon black. However, in the case of near-nano cemented carbide even insignificant additions of W metal or carbon black are found to lead in defects of the microstructure, such as fields enriched with Co (Co lakes) and/or abnormally large WC grains. Moreover, when taking into account that the powder WC—Co mixtures containing near-nano WC are heavily oxidised, the mixtures have to be annealed in a reducing gas atmosphere.

When taking into account the above-mentioned problems, there is a need for new compositions of near-nano cemented carbide having further enhanced carbon content indicated by the cemented carbide magnetic saturation. Also, a new method of regulation of carbon content in green parts of near-nano cemented carbides is needed.

There is a need to provide near-nano cemented carbide with an improved combination of hardness, fracture toughness and wear-resistance.

### SUMMARY

According to a first aspect of the present invention, there is provided a cemented carbide comprising WC grains, about 3 wt. % to 20 wt. % binder selected from Co or Co and Ni and grain growth inhibitors wherein the WC mean grain size lies in the range of about 180 nm and about 230 nm, at least 10±2% WC grains are finer than about 50 nm and 7±2% WC grains have a size from about 50 to about 100 nm.

The term “wt. %” refers to percentage by weight.

In one embodiment of the invention, the grain growth inhibitor is selected from Cr, V, Zr, Ta and Mo and may be present as carbides.

In one embodiment of the invention, the grain growth inhibitor content with respect to the binder comprises about 3 wt. % to 11 wt. % Cr and about 1 wt. % to 4 wt. % V.

In one embodiment of the invention, the grain growth inhibitor content with respect to the binder content comprises about 3 wt. % toll wt. % Cr; about 1wt. % to 4 wt. % V; about 0.1 wt. % to 8 wt. % Zr; about 0.1 wt. % to 5 wt. % Ta and/or about 0.1 wt. % to 10.0 wt. % Mo.

In one embodiment of the invention, the binder includes tungsten dissolved therein and the concentration of tungsten dissolved in the binder lies in the range of about 14 wt. % to 25 wt. %, which is indicated by the magnetic moment/unit wt. of the cemented carbide according to the equations:

σ_{cc}=σ_{B}B/100

σ_{B}=σ_{Co}−0.275 M_{w},

where σ_{cc} is the magnetic moment of the cemented carbide in units of micro-Tesla times cubic metre per kilogram, σ_{Co} is the magnetic moment of pure cobalt in units of micro-Tesla times cubic metre per kilogram, B is the binder fraction in the cemented carbide in wt. %, σ_{B} is the magnetic moment of the binder in units of micro-Tesla times cubic metre per kilogram and M, is the concentration of tungsten dissolved in the binder in wt. %.

In one embodiment of the invention, the concentration of tungsten dissolved in the binder lies in the range of about 16 wt. % to about 25 wt. %.

In one embodiment of the invention, the concentration of tungsten dissolved in the binder lies in the range of about 18 wt. % to about 25 wt. %.

In one embodiment of the invention, the coercive field strength of the cemented carbide lies in the range of about 32 kA/m to about 72 kA/m (kilo Amperes per metre).

In one embodiment of the invention, the toughness-hardness coefficient obtained by multiplication of indentation fracture toughness in MPa·m^{1/2} and Vickers hardness in GPa lies above about 180, and in one embodiment of the invention, the toughness-hardness coefficient obtained by multiplication of indentation fracture toughness in MPa·m^{1/2} and Vickers hardness in GPa lies above about 200.

In one embodiment of the invention, the cemented carbide exhibits wear measured according to the ASTM B611 test in cm³/rev. of below about 0.12 Y 10⁻⁵, where Y is the binder fraction, in wt. %.

In one embodiment of the invention, the cemented carbide comprises neither free carbon nor eta-phases.

In one embodiment of the invention, the grain growth inhibitors are present in the form of solid solution in the binder.

In one embodiment of the invention, the grain growth inhibitors are present in form of carbides.

In a further embodiment of the invention, there is provided a cemented carbide comprising WC grains with mean grain size of below 0.3 micron, in one embodiment below 0.2 micron, 3-20 wt. % binder selected from Co or Co and Ni and grain growth inhibitors selected from Cr, V, Zr, Ta and Mo wherein the inhibitor content with respect to the binder content is 3 wt. % to 12 wt. % Cr, preferably 8 wt. % to 10 wt. % Cr; 1 wt. % to 8 wt. % V, preferably 2 wt. % to 5 wt. % V; 0.5 wt.5 to 8 wt. % Zr, preferably 0.8 wt. % to 1.5 wt. % Zr; 0.5 wt. % to 5 wt. % Ta, preferably 0.8 wt. % to 1.5 wt. % Ta; and 2.5 wt. % to 10.0 wt. % Mo, preferably 3.0 wt. % to 5.0 wt. % Mo. and the magnetic moment, a, in units of micro-Tesla times cubic metre per kilogram lies in the range from 0.08 X to 0.13 X, where X is the cobalt fraction, in wt. %.

It has surprisingly been found that near-nano cemented carbide with a WC mean grain size lying in the range of about 180 nm to 230 nm exhibits a very high combination of hardness, wear-resistance and fracture toughness. Such near-nano cemented carbide can be obtained by use of Co or Co+Ni binders and the following amounts of grain growth inhibitors with respect to the binder content: of 5 wt. % to 12 wt. % Cr, preferably 8 wt. % to 10 wt. % Cr; 1 wt. % to 5 wt. % V, preferably 2 wt. % to 4 wt. % V; 0.5 wt. % to 2 wt. % Zr, preferably 0.8 wt. % to 1.5 wt. % Zr; 0.5 wt. % to 2 wt. % Ta, preferably 0.8 wt. % to 1.5 wt. % Ta; and 2.5 wt. % to 5.0 wt. % Mo, preferably 3.0 wt. % to 4.0 wt. % Mo. The near-nano cemented carbides of the present invention must have a certain low level of carbon content and correspondingly the magnetic moment, σ, in units of micro-Tesla times cubic metre per kilogram lies in the range from 0.08 X to 0.13 X, preferably 0.09 X to 0.12 X, most preferably 0.09 X to 0.11 X, where X is the cobalt fraction, in wt. %. In one embodiment, the magnetic moment lies in the range from 0.092 X to 0.122 X, preferably 0.092 X to 0.117 X, most preferably 0.092 X to 0.111 X. At lower values of magnetic moment, eta-phase (Co3W3C or Co6W6C) forms in the microstructure and at higher values of magnetic moment both the fracture toughness and hardness of the near-nano cemented carbides decrease.

The toughness-hardness coefficient obtained by multiplication of fracture toughness in MPa·m^{1/2} and Vickers hardness in GPa may lie above 190.

According to a second aspect of the present invention there is provided a process for production of cemented carbide according to the invention as hereinbefore described including the following stages:
milling WC powder with specific surface area (BET) of about 3.0 m²/g or higher with binder and grain-growth inhibitors;
pressing green parts;
pre-sintering the green parts in H2 at about 400° C. to about 900° C. (degrees Centigrade) for about 5 min. to about 30 min;
sintering in vacuum at temperatures of about 1340° C. to about 1410° C. for about 3 min to about 20 min; and
HIP-sintering in Ar at pressures of about 40 to about 100 bar at temperatures of about 1340° C. to about 1410° C. for about 1 to about 20 min.

It has surprisingly been found that the carbon content in the green articles of the near-nano cemented carbides with the composition and WC grain sizes mentioned above according to the first aspect of the present invention can be precisely regulated by pre-sintering in pure hydrogen at temperatures of about 400° C. to about 900° C. and finally sintered in vacuum and Ar under pressure.

Such near-nano cemented carbides have an exceptionally high combination of hardness, fracture toughness and wear-resistance.

### DRAWING CAPTIONS

Embodiments will be described by way of non-limiting examples, and with reference to the accompanying drawings in which:

FIG. 1A shows an FE-SEM image of the microstructure of the near-nano cemented carbide according Example 1, FIG. 1B shows the corresponding FE-SEM image after computer image processing, and FIG. 1C shows corresponding light-microscopy image.

FIG. 2A shows a graph of the wear of the near-nano (NN) cemented carbide according to Example 1 in comparison with those of conventional ultra-fine (UF) cemented carbides (WC mean grain size of nearly 0.8 μm) with 10 and 7% Co. FIG. 2B shows a graph of the corresponding fracture toughness.

FIG. 3 shows the microstructure of the near-nano cemented carbide according Example 2 (light-microscopy).

FIG. 4A shows a graph of the wear of the near-nano (NN) cemented carbide according to Example 2 in comparison with those of conventional ultra-fine (UF) cemented carbide (WC mean grain size of nearly 0.8 μm) with 5% Co. FIG. 4B shows a graph of the corresponding fracture toughness.

### DETAILED DESCRIPTION

Measurements of magnetic properties are widely used in the cemented carbide industry. Both coercive force and magnetic moment are measured for these purposes. The coercive force indicates the thickness of Co interlayers among WC grains and consequently WC mean grain size. The amount of tungsten dissolved in the Co-based binder can be assessed by measurement of magnetic moment or magnetic saturation of cemented carbides because the saturation value of Co decreases linearly with the addition of tungsten in solution (see B. Roebuck & E. Almond., Int. Mater Rev., 33 (1988) 90-110). It is well known that the concentration of tungsten dissolved in the binder increases when decreasing the total carbon content, so that the magnetic moment shows indirectly the total carbon content in cemented carbides. The equation indicating the dependence of magnetic moment of cemented carbide on the concentration of tungsten dissolved in the binder is the following (see. B. Roebuck. Int. J, Refractory Met. Hard Mater., 14 (1996) 419-424): σB=σCo−0.275 Mw, where σCo is the magnetic moment of pure cobalt in units of micro-Tesla times cubic metre per kilogram, σB is the magnetic moment of the binder in units of micro-Tesla times cubic metre per kilogram and Mw is the concentration of tungsten dissolved in the binder in wt. %.

It is well known that in WC—Co cemented carbides not containing η-phase (Co3W3C or Co6W6C) when the total carbon content decreases the concentration of tungsten dissolved in the binder strongly increases, which is indicated by decreasing the magnetic moment. In such cemented carbides the WC grains in the microstructure become significantly finer compared to cemented carbides with medium or high total carbon content and consequently with lower concentrations of tungsten dissolved in the binder. In other words, high concentrations of tungsten dissolved in the binder act as “a grain growth inhibitor” suppressing the process of re-crystallisation of fine grain WC fraction and growth of large WC single-crystals (see I. Konyashin, et al. Int. J. Refractory Met. Hard Mater., 27 (2009) 234-243). The major advantage of employing high concentrations of tungsten dissolved in the binder as “a grain growth inhibitor” compared to conventional grain growth inhibitors (Cr, V, etc.) is that the fracture toughness of extremely fine-grained with high concentrations of tungsten dissolved in the binder does not decrease or decreases to a lesser extent compared to cemented carbides with medium or low concentration of tungsten dissolved in the binder, but containing a large amount of the conventional grain growth inhibitors. This is related to the fact that the conventional grain growth inhibitors segregate at WC—Co interfaces leading to their “weakening” and a decreased fracture toughness (see e.g. S. Lay et al Int. J. Refractory Met. Hard Mater., 20 (2002) 61-69), whereas in the cemented carbides with high concentration of tungsten dissolved in the binder the WC—Co interfaces remain unchanged (see I. Konyashin et al. Int. J. Refractory Met. Hard Mater., 28 (2010) 228-237). Therefore, it is possible to achieve higher combinations of hardness and fracture toughness of near-nano cemented carbides by using high concentrations of tungsten dissolved in the binder. The use of high concentration of tungsten dissolved in the binder can be combined with the employment of a certain type and amount of conventional grain growth inhibitors.

It has surprisingly been found that when the concentration of tungsten dissolved in the binder varies from 14 wt. % to 25 wt. %, preferably 16 wt. % to 25 wt. %, most preferably 18 wt. % to 25 wt. % the hardness of near-nano cemented carbides can be increased without loosing their fracture toughness. In other words, the near-nano cemented carbides with a certain combinations of microstructure characteristics and with high concentrations of tungsten dissolved in the binder possess an unexpectedly high combination of hardness and fracture toughness as well as very high wear-resistance. The concentration of tungsten dissolved in the binder should be on the one hand as high as possible, but on the other hand be limited by the fact that, at a certain concentration of tungsten dissolved in the binder, eta-phases (Co3W3C and Co6W6C) form in the microstructure. The formation of eta-phases is very undesirable, as it leads to a dramatic decrease of the cemented carbide transverse rupture strength.

### EXAMPLES

Embodiments of the invention are described in more detail with reference to the examples below, which are not intended to limit the invention.

### Example 1

Tungsten carbide powder (4NPO from H.C. Starck™, Germany) with the specific surface (BET) of 4.0 m²/g measured according to the ASTM 3663 standard and carbon content of 6.14 wt. %, was blended with about 10 wt. % cobalt powder, wherein the Co grains had an average grain size of about 1 micron, 0.8 wt. % Cr3C2, 0.3 wt. % VC, 0.5 wt. % Mo2C, 0.1 wt. % TaC and 0.1 wt. % ZrC. The blend was produced by milling the powders together for 24 hrs by means of a ball mill in a milling medium consisting of hexane with 2 wt. % paraffin wax, and using a powder-to-ball ratio of 1:6. After drying the blend, samples of various sizes including those for examining transverse rupture strength (TRS) according to the ISO 3327-1982 standard and wear-resistance according to the ASTM B611-85 standard were pressed and heat-treated in hydrogen at 700° C. centigrade for 20 min. The green bodies were then sintered at 1370° C. for 20 min, including a 10 minute vacuum sintering stage and a 10 minute high isostatic pressure (HIP) sintering stage carried out in an argon atmosphere at a pressure of 50 bar.

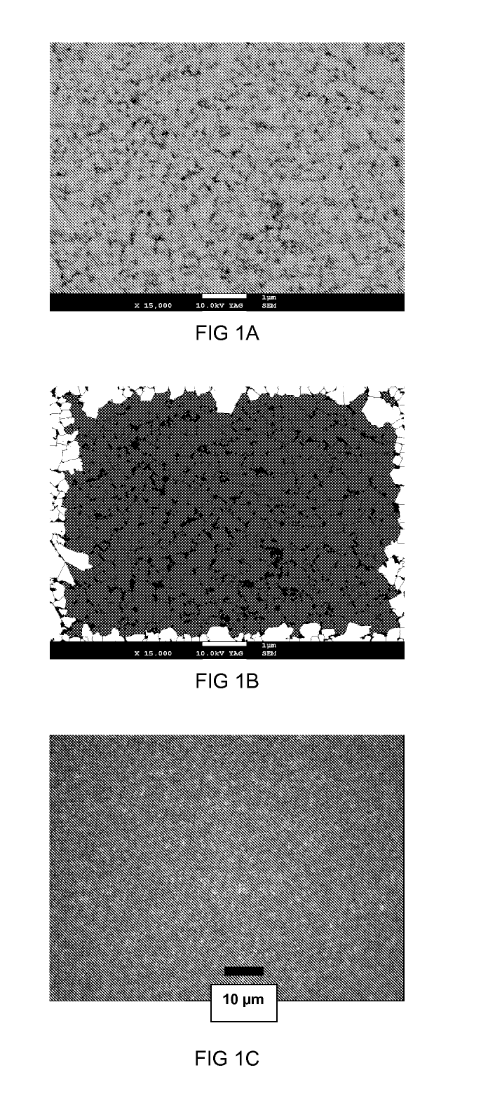

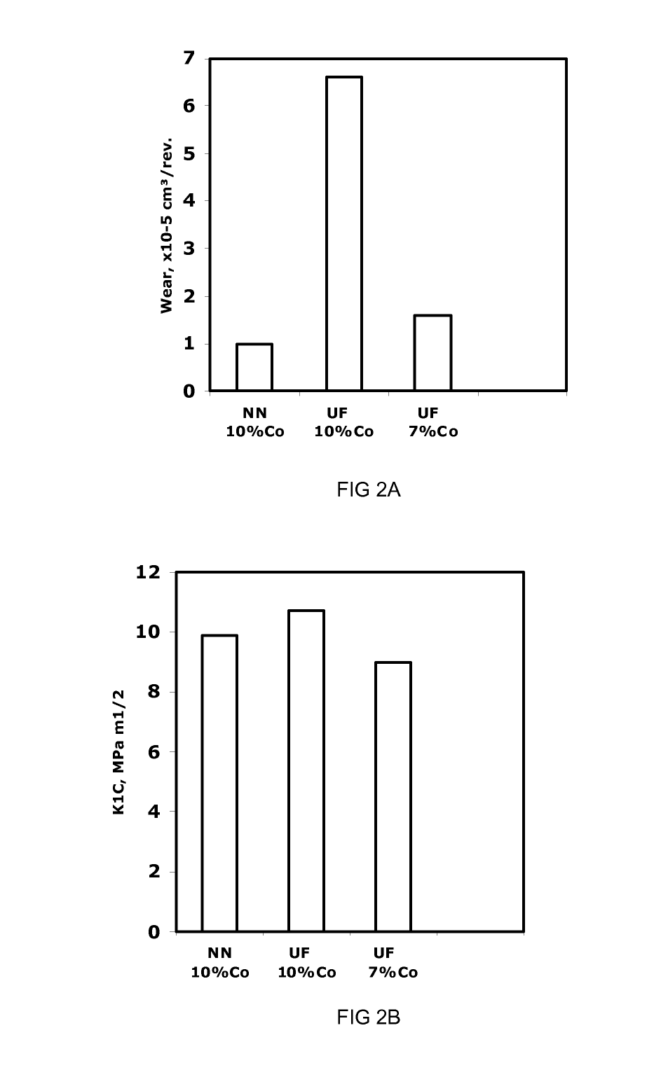

Metallurgical cross-sections were made and examined by use of a light microscope and a FE-SEM. FIG. 1A, FIG. 1B and FIG. 1C show the microstructure of the cemented carbide. It clearly seen that there is neither free-carbon nor θ-phase in the microstructure and it is fine and uniform. The microstructure obtained on the FE-SEM was analysed using the AnalySIS™ software from the company “Soft Imaging System™” (SIS). The WC mean grain size was found to be equal to 0.20 micron, the percentage of grains finer than 50 nm was found to be 9.6% and that of grains of 50 to 100 nm was found to be 7.0%. The properties of the cemented carbide were as follows: density—14.24 g/cm³, TRS—3300 MPa, HV20—20.5 GPa, coersivity—40.6 kA/m, magnetic moment—1.1 μT m³/kg, fracture toughness—9.9 MPa·m^{1/2}, wear—1.0 10⁻⁵ cm³/rev. Thus, the toughness-hardness coefficient obtained by multiplication of fracture toughness in MPa·m^{1/2} and Vickers hardness in GPa is equal to roughly 203. The concentration of tungsten dissolved in the binder calculated on the basis of the magnetic moment value is equal to 18.5 wt. %. FIG. 2A and FIG. 2B show the wear-resistance and fracture toughness of the near-nano cemented carbide in comparison with conventional ultra-fine grades with WC mean grain size of 0.8 micron with 10% Co and 7% Co. The microstructure of the conventional grades does comprise grains finer than 100 nm, they contain 0.3 wt. % VC and 0.2 wt. % Cr3C2 and the concentration of tungsten dissolved in the binder of these grades was below 10 wt %. It is clearly seen that the wear-resistance of the near-nano cemented carbide is significantly higher than that of the conventional grades, which is achieved by only an insignificant decrease in fracture toughness compared to the conventional grade with 10% Co, and higher fracture toughness compared to the conventional grade with 7% Co. The hardness of the ultra-fine grade with 7% Co is 17.0 GPa and its fracture toughness is 9.2 MPa·m^{1/2}, so that the toughness-hardness coefficient of this grade is equal to 156, which is significantly lower than that of the new near-nano cemented carbide. The hardness of the ultra-fine grade with 10% Co is 15.0 GPa and its fracture toughness is 10.7 MPa·m^{1/2}, so that the toughness-hardness coefficient of this grade is equal to 160, which is significantly lower than that of the new near-nano cemented carbide.

### Example 2

Tungsten carbide powder (4NPO from H.C. Starck™, Germany) with the specific surface (BET) of 4.0 m²/g measured according to the ASTM 3663 standard and carbon content of 6.14 wt. %, was blended with about 5 wt. % cobalt powder, wherein the Co grains had an average grain size of about 1 micron, 0.4 wt. % Cr3C2, 0.15 wt. % VC, 0.25 wt. % Mo2C, 0.05 wt. % TaC and 0.05 wt. % ZrC. The blend was produced by milling the powders together for 24 hours by means of a ball mill in a milling medium consisting of hexane with 2 wt. % paraffin wax, and using a powder-to-ball ratio of 1:6. After drying the blend, samples of various sizes including those for examining transverse rupture strength (TRS) according to the ISO 3327-1982 standard and wear-resistance according to the ASTM B611-85 standard were pressed and heat-treated in hydrogen at 700° C. centigrade for 20 min. The green bodies were then sintered at 1390° C. for 20 min, including a 10 minute vacuum sintering stage and a 10 minute high isostatic pressure (HIP) sintering stage carried out in an argon atmosphere at a pressure of 50 bar.

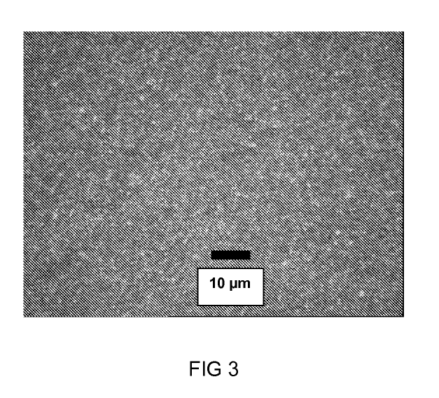

Metallurgical cross-sections were made and examined by use of a light microscope. FIG. 3 shows the microstructure of the cemented carbide. It can clearly be seen that there is neither free-carbon nor eta-phase in the microstructure and it is fine and uniform; the cross-sections were also examined on the FE-SEM. The microstructure obtained on the FE-SEM was analysed using the AnalySIS™ software from the company “Soft Imaging System™” (SIS). The WC mean grain size was found to be equal to 0.19 micron, the percentage of grains finer than 50 nm was found to be 9.0% and that of grains of 50 to 100 nm was found to be 6.4%.

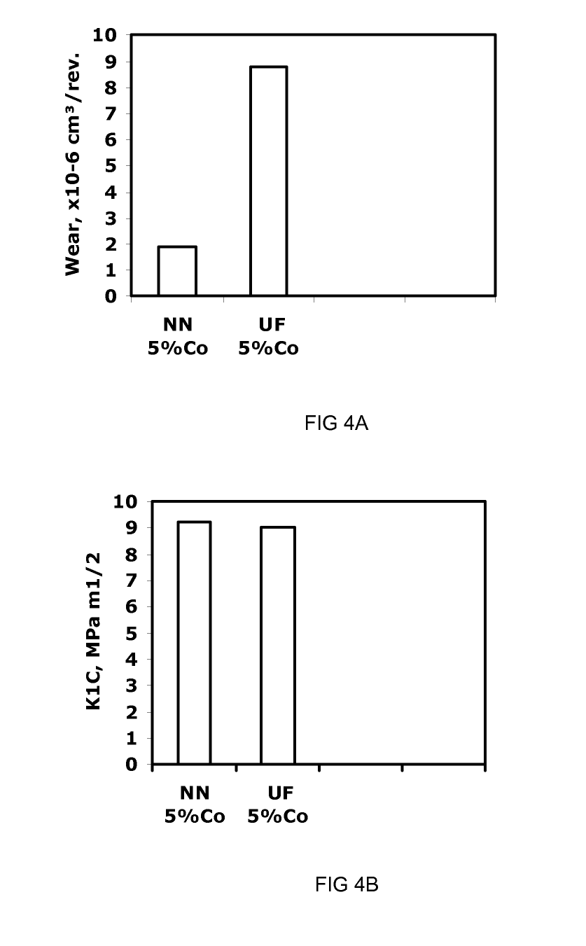

The properties of the cemented carbide are the following: density—14.98 g/cm³, TRS—2500 MPa, HV20—22.5 GPa, coersivity—43.0 kA/m, magnetic moment—0.5 μT m³/kg, fracture toughness—9.2 MPa m^{1/2}, wear—1.9 10⁻⁶ cm³/rev. Thus, the toughness-hardness coefficient obtained by multiplication of fracture toughness in MPa·m^{1/2} and Vickers hardness in GPa is equal to roughly 207. The concentration of tungsten dissolved in the binder calculated on the basis of the magnetic moment value is equal to 22.2 wt. %. FIG. 4A and FIG. 4B show the wear and fracture toughness of the near-nano cemented carbide in comparison with a conventional ultra-fine grade with WC mean grain size of 0.8 μm with 5% Co. The microstructure of the conventional grade does comprise grains finer than 100 nm, it contains 0.2 wt. % VC and 0.1 wt. % Cr3C2 and the concentration of tungsten dissolved in the binder of the grade was below 9 wt %. It is clearly seen that the wear-resistance of the new near-nano cemented carbide is significantly higher than that of the conventional grade, which is achieved without losing fracture toughness. The hardness of the conventional ultra-fine grade with 5% Co is 17.8 GPa and its fracture toughness is 9.0 MPa·m^{1/2,} so that the toughness-hardness coefficient of this grade is equal to 160, which is significantly lower than that of the near-nano cemented carbide.

1. A cemented carbide comprising WC grains, about 3 wt. % to 20 wt. % binder selected from Co or Co and Ni and grain growth inhibitors wherein the WC mean grain size lies in the range of about 180 nm and about 230 nm, at least 10±2% of the WC grains are finer than about 50 nm and 7±2% WC grains have a size from about 50 to 100 nm.

2. A cemented carbide according to claim 1 wherein the concentration of tungsten dissolved in the binder lies in the range of about 14 wt. % to 25 wt. %, which is indicated by the magnetic moment/unit wt. of the cemented carbide according to the equations:
σ_{cc}=σ_{B}B/100
σ_{B}σ_{Co}−0.275 M_{w},
where σ_{cc} is the magnetic moment of the cemented carbide in units of micro-Tesla times cubic metre per kilogram, σ_{Co}, is the magnetic moment of pure cobalt in units of micro-Tesla times cubic metre per kilogram, B is the binder fraction in the cemented carbide in wt. %, σ_{B} is the magnetic moment of the binder in units of micro-Tesla times cubic metre per kilogram and M_{w}, is the concentration of tungsten dissolved in the binder in wt. %.

3. A cemented carbide according claim 1 wherein the concentration of tungsten dissolved in the binder lies in the range of about 16 wt. % to 25 wt. %.

4. A cemented carbide according to claim 1 wherein the concentration of tungsten dissolved in the binder lies in the range of about 18 wt. % to 25 wt. %

5. A cemented carbide according to claim 1 wherein the grain growth inhibitor content with respect to the binder comprises about 3 wt. % to 11 wt. % Cr and about 1 wt. % to 4 wt. % V.

6. A cemented carbide according claim 1 wherein the grain growth inhibitor content with respect to the binder content comprises about 3 wt. % to 11 wt. % Cr; about 1 wt. % to 4 wt. % V; about 0.1 wt. % to 8 wt. % Zr; about 0.1 wt. % to 5 wt. % Ta and/or about 0.1 wt. % to 10.0 wt. % Mo.

7. A cemented carbide according to claim 1 wherein the coercive field strength of the cemented carbide lies in the range of about 32 kA/m to 72 kA/m.

8. A cemented carbide according to claim 1 wherein the toughness-hardness coefficient obtained by multiplication of indentation fracture toughness in MPa·m^{1/2} and Vickers hardness in GPa lies above about 180.

9. A cemented carbide according to claim 1 wherein the toughness-hardness coefficient obtained by multiplication of indentation fracture toughness in MPa·m^{1/2} and Vickers hardness in GPa lies above about 200.

10. A cemented carbide according to claim 1 wherein the cemented carbide exhibits wear measured according to the ASTM B611 test in cm³/rev. of below about 0.12 Y 10⁻⁵, where Y is the binder fraction, in wt. %.

11. A cemented carbide according to claim 1 wherein the cemented carbide comprises neither free carbon nor eta-phases.

12. A cemented carbide according to claim 1 wherein the grain growth inhibitors are present in form of solid solution in the binder.

13. A cemented carbide according to claim 1 wherein the grain growth inhibitors are present in form of carbides.

14. A process for production of cemented carbide according to claim 1 including the following stages:
milling WC powder with specific surface area (BET) of about 3.0 m²/g or higher with binder and grain-growth inhibitors;
pressing green parts;
pre-sintering the green parts in H2 at about 400° C. to about 900° C. for about 5 to about 30 min;
sintering in vacuum at temperatures of about 1340° C. to about 1410° C. for about 3 min to about 20 min; and
HIP-sintering in Ar at pressures of about 40 to about 100 bar at temperatures of about 1340° C. to about 1410° C. for about 1 to about 20 min.
